(19) United States
(12) Patent Application Publication
(10) Pub. No.: US 2014/0007476 A1
(43) Pub. Date: Jan. 9, 2014

(54) DISPLAY SIGN

(71) Applicant: SIGN RIDER STORE, LLC, Hoboken, NJ (US)

(72) Inventors: Daniel M. D'Andrea, Lavallette, NJ (US); Jeffrey M. D'Andrea, Hoboken, NJ (US)

(73) Assignee: SIGN RIDER STORE, LLC, Hoboken, NJ (US)

(21) Appl. No.: 13/932,582

(22) Filed: Jul. 1, 2013

Related U.S. Application Data
(60) Provisional application No. 61/666,284, filed on Jun. 29, 2012.

(51) Int. Cl. G09F 7/00

(52) U.S. Cl. CPC G09F 7/00
USPC 40/611.01; 29/525.01

(57) ABSTRACT

The present invention relates to a display sign that includes a display panel associated with a rigid insert, sealed in a protective sign sleeve and attachable to a surface using a variety of fasteners that can be used for marketing or advertising for any product or service.

### FIELD OF THE INVENTION

The present invention relates to a display sign that includes a display panel associated with a rigid insert, sealed in a protective sign sleeve and attachable to a surface using a variety of fasteners to hang or ride a rider sign that can be used for marketing or advertising for any product or service.

### BACKGROUND OF THE INVENTION

1. Field of the Invention

The present invention relates to protective sign sleeve and as the first primary market more specifically to sign rider kits for real estate including a series of sizes of protective sign sleeves used for displaying real estate (e.g., sale/rental/lease) signs and real estate rider signs. Similar sign rider kits in various sizes can be created for any company looking to advertise their products or services using a display sign in any market.

2. Description of the Related Art

Real estate professionals are often required to carry numerous necessities from property to property during the ordinary course of business. These necessities include real estate signs (such as those used in the sale, rental, or lease of real estate) and real estate rider signs. Real estate agents want to please their customers and want to market their listings immediately with all marketing tools. Sign riders can be agent, company or listing specific and provide contact information so a potential client can call to get property specific information. However, many of these items are heavy and cumbersome, which makes them difficult to store and carry. Furthermore, sale signs and rider signs are also very expensive, and require time to be ordered, proofed, received and taken to the listing property. Rider signs have a typical lead-time of 2 to 6 days to be printed and then subsequently shipped from the printer to the real estate agent. This lead time eliminates the ability for agents to use sign riders with property specific information for rental properties that may rent within a couple of days before the sign arrives.

FIG. 1 provides is an example of a typical realty sign 100 found in the prior art. The sign is typically constructed of aluminum, steel, polyethylene and/or plastic fluted corrugated and will display brand identity of the Real Estate Agency that is listing the property. When it comes to selling, real estate leads are very important and on site realty signs are key marketing tools to generate leads. This type of sign is placed on property in various locations where there is good visibility such as a sign holder on the lawn, fastened to a fence, rail or mailbox, placed inside a front window or on a door. Accordingly, the potential customers get contact information if they are interested in viewing the property. This sign promotes the listing property for people who are interested or friends of people who are walking, running, riding a bike or driving by.

FIG. 2 depicts a sign rider 150 that can be attached on the top or bottom of realty sign 100. Sign rider 150 may carry agent specific contact information (such as the agent's name, photo, phone number, website, SMS text number or Agency information). Sign riders such as these are used to highlight property features such as: For Sale, For Lease, For Rent, Open House, Contract Pending, Foreclosure, Sold, 4bed/3bath, Renovated kitchen with stainless steel appliances, including any property or features descriptors, in addition to Agent features. Real Estate Sign Riders can make one important piece of information stand out or allow you to add to existing older signage. In some cases sign riders are the only Real Estate Signs used on a listing property.

Real estate professionals need to generate sign riders in their own local office fast and cost effectively. Real estate professionals need the flexibility to print what they want, when the want it, such as unique property features. Information will vary with each listing and may include key agency and/or agent or property specific information, and then sending that information to your desktop or office printer, then assembling a sign rider using components from sign rider kits. These kits will enable the agent, agency, broker, association or real estate professional to print a sign on location at their office using letter, legal or ledger paper; folding and associating the printed sign with a rigid plastic insert, placing the sign into a protective sign sleeve, adding fasteners where needed to hang or ride the sign rider to a real estate sign, fence, rail, mailbox, building, etc. . . . This process will take a few minutes and can be placed at the listing property the same day the property is listed enabling real estate professionals to capitalize on this critical marketing opportunity. This new process will be a fraction of the cost of a traditional rider sign. Hence, the real estate sign kit will save the Agent valuable time and money; savings of which can be passed on to the consumer.

None of the above, taken either singly or in combination, is seen to describe the instant invention as claimed. Thus, a protective sleeve sign rider kit that solves the aforementioned problems is desired.

### SUMMARY OF THE INVENTION

In some embodiments, a real estate sign is provided, where the real estate sign includes a protective plastic sign sleeve, where the sleeve includes a flap and at least one opening; a rigid insert; a sign including indicia, wherein the sign is associated with the rigid insert; at least one hang tab; at least one end flap label; and a fastener.

In some embodiments, a real estate sign kit is provided, where the kit includes a plurality of protective plastic sign sleeves; a plurality of rigid inserts; a plurality of fasteners; a plurality of hang tabs; a plurality of end flaps; and an assembly instructions set.

In some embodiments, a method for creating a real estate sign is provided, where the method includes, printing a sign including indicia; associating the sign with a rigid insert; obtaining a protective plastic sign sleeve, where the plastic sleeve includes an outer surface, an inner surface, at least one opening and a flap associated with the opening; inserting the sign and insert into the opening of the plastic sleeve; sealing the flap to the outer surface of the plastic sleeve; associating at least one hang tab to the outer surface of the plastic sleeve; hanging or riding the hang tab and/or protective plastic sign sleeve to a surface with at least one fastener.

### BRIEF DESCRIPTION OF THE DRAWINGS

FIG. 1 is a front perspective of the prior art.

FIG. 2 is a front perspective of sign rider.

FIG. 3 is a perspective view of the inventive rider in combination with the prior art.

FIG. 4 is a perspective view and side profile of the inventive rider.

FIG. 5 is a perspective view and side profile of the inventive rider.

FIG. 6 is a perspective view of a kit of the present invention.

FIG. 7 is a perspective view of a sign rider kid of the present invention.

FIG. 8 is a perspective view of a set of instructions for assembling a kit of the present invention.

FIG. 9A, 9B, 9C, and 9D are examples of various types of hang tabs.

FIG. 10 is a perspective view of hang tabs of the present invention attached to a sign rider of the present invention.

FIG. 11A, 11B, 11C, 11D, 11E, and 11F are a perspective views of various ways to attach a sign rider of the present invention.

FIG. 12A, 12B, 12C, 12D, 12E, 12F, 12G, 12H, 12I, 12J, and 12K are examples of various types of indicia that may be found on the present invention.

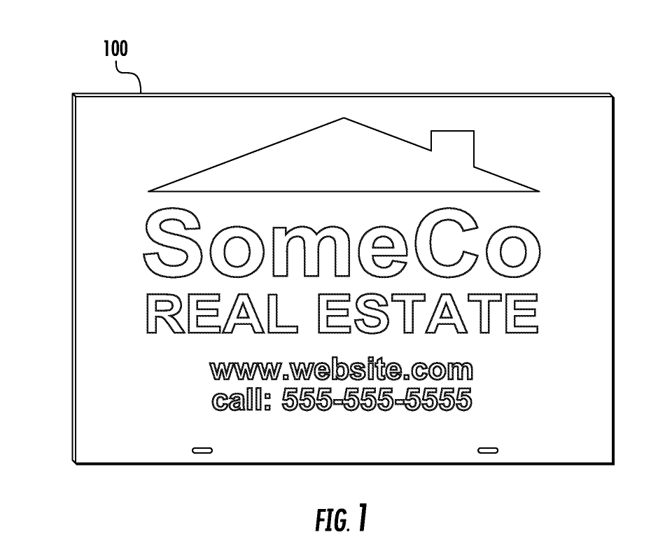

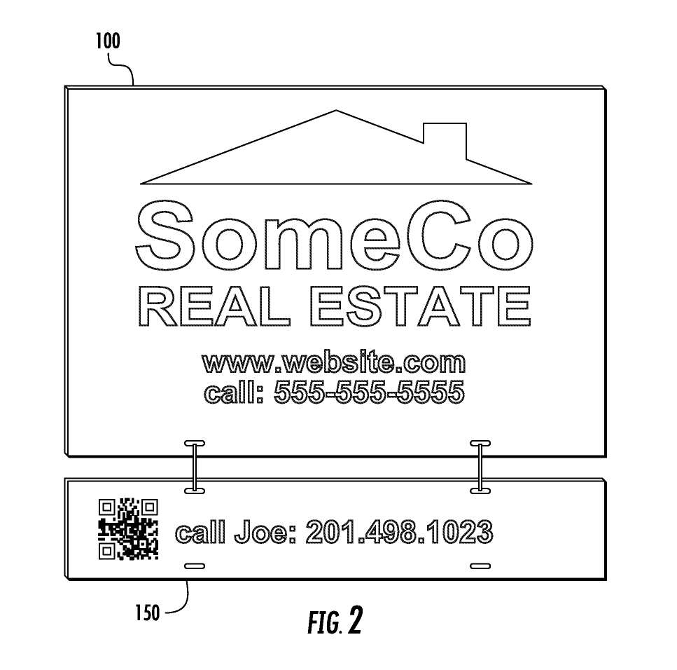

### DETAILED DESCRIPTION OF THE INVENTION

While this invention is susceptible to embodiment in many different forms, there is shown in the drawings, and will herein, be described in detail specific embodiments, with the understanding that the present disclosure of such embodiments is to be considered as an example of the principles, and not intended to limit the invention to the specific embodiments shown and described. In the description below, like reference numerals are used to describe the same, similar, or corresponding parts in the several views of the drawings. This detailed description defines the meaning of the terms used herein, and specifically describes embodiments in order for those skilled in the art to practice the invention.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (e.g., open language). The term “coupled”, as used herein, is defined as connected, although not necessarily directly, and not necessarily mechanically.

Reference throughout this document to “one embodiment”, “certain embodiments”, and “an embodiment”, or similar terms means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner in one or more embodiments without limitation.

The term “or”, as used herein, is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps, or acts are in some way inherently mutually exclusive

The present invention is a protective sign sleeve that a real estate professional can print and assemble instantaneously in the local office with a standard printer and paper at a fraction of the cost of a traditional sign rider. These signs can be put together with sign rider kits (such as sign riders to be used with real estate). Kit includes all materials for this purpose including but not limited to protective sign sleeves, rigid plastic inserts, hang tabs, end flap labels and fasteners.

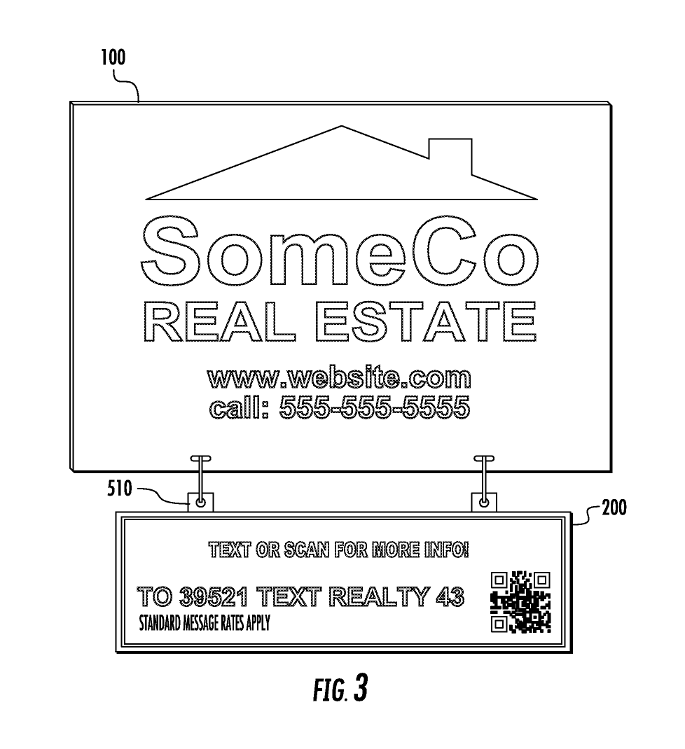

Sign rider 200, as depicted in FIG. 3, may be attached to a traditional sign 100 with hang tabs 510. The sign rider to the present invention enables real estate professionals to print a sign rider with any information they want instantaneously and insert it into the protective sign sleeve to create a sign rider fast and at a fraction of the cost of a traditional sign rider and apply it on-location the same day.

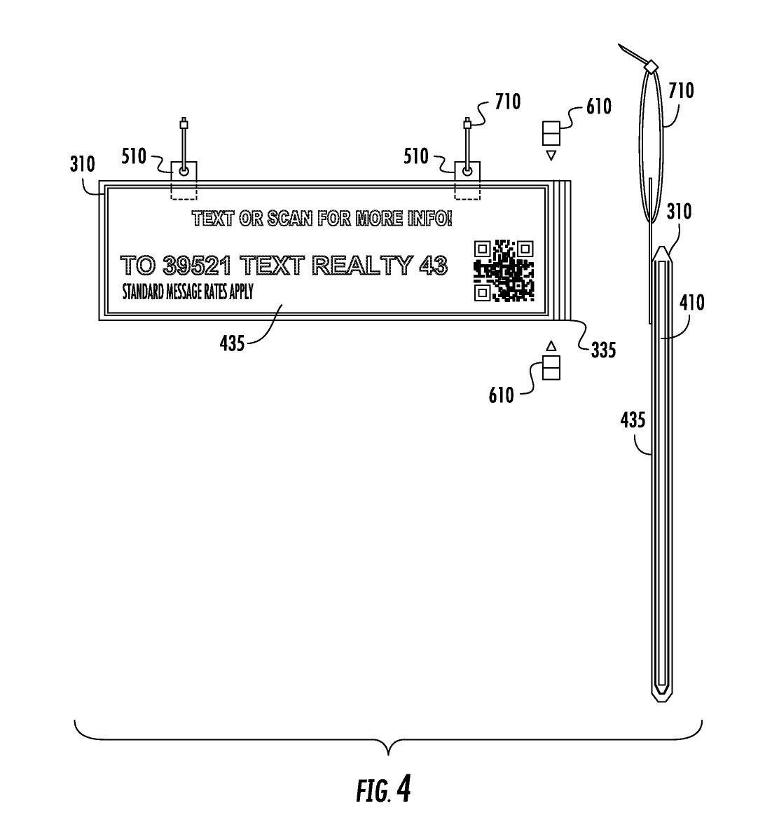

FIG. 4 represents a real estate sign rider 200 of the present invention in further detail. Individual components have been labeled as follows: Protective Sign Sleeve 310, Adhesive Flap on Protective Sign Sleeve 335, Rigid Plastic Insert 410, Printed Paper Sign 435, Hang Tabs 510, Permanent Adhesive End Flap Labels 610, and Fasteners 710. The Protective Sign Sleeve 310 is a transparent material sleeve designed to hold the Printed Paper Sign 435 wrapped around the Rigid Plastic Insert 410. The Adhesive Flap 335 on the Sign Sleeve 310 is a strip (e.g., ½″, ¾″, 1″ or any other strip size) of permanent adhesive that will fold over to seal the Protective Sign Sleeve 335 and protect the Printed Paper Sign 435 from moisture, water and the elements (wind, rain, sleet, snow, etc.). Permanent adhesive end flap labels 610 can be added to the top and bottom of the flap seal to ensure waterproof protection. The Rigid Plastic Insert 410 will provide structure to the Printed Paper Sign 435 to prevent damage to the printed information (e.g., folds, creases, bending, paper tears, etc). The Hang Tab 510 is constructed of a rigid or flexible plastic top with a hanger hole such as triangle, round or Euro hole and a permanent adhesive pressure sensitive bottom that will be mounted on the Sign Sleeve to enable fastening. The Permanent Adhesive End Flap Labels 610 is a transparent pressure sensitive material made with a permanent adhesive that will prevent water or any moisture from penetrating the Protective Sign Sleeve 310. The Fastener (e.g., cable tie) is a rigid or flexible plastic fastener that will be used to attach the Sign Rider 200 for advertising.

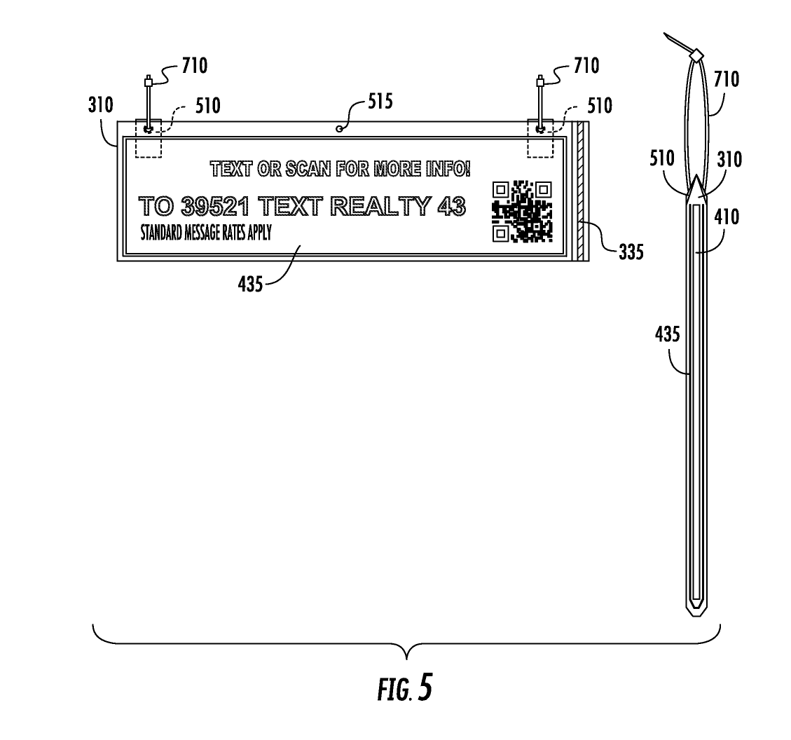

FIG. 5 describes another embodiment of sign rider 200. Individual components have been labeled as follows: Protective Sign Sleeve 310, Adhesive Flap on Protective Sign Sleeve 335, Rigid Plastic Insert 410, Printed Paper Sign 435, Hang Tabs 510 that may be aligned with the built in hang holes to provide re-enforcement, Permanent Adhesive End Flap Labels 610 that may be selected from: Cable Tie, Rider-Clip, Tri-Clip, H-Clip, and Fasteners 710. The Protective Sign Sleeve is a transparent material sleeve designed to hold the Printed Paper Sign wrapped around the Rigid Plastic Insert. The Adhesive Flap on the Sign Sleeve is a strip (e.g., ½″, ¾″, 1″ or any other strip size) of permanent adhesive that will fold over to seal the Protective Sign Sleeve and protect the Printed Paper Sign from moisture, water and the elements (wind, rain, sleet, snow, etc.). The Rigid Plastic Insert will provide structure to the Printed Paper Sign to prevent damage to the printed information (e.g., folds, creases, bending, paper tears, etc). Hang Holes are manufactured into the Protective Sign Sleeve. The Adhesive Hang Tab can be aligned with the built in Hang Holes for re-enforcement strength. The Fastener (e.g., cable tie, Rider-Clip, Tri-Clip, H-Clip) is a rigid or flexible plastic fastener that will be used to hang or ride the Sign Rider for advertising.

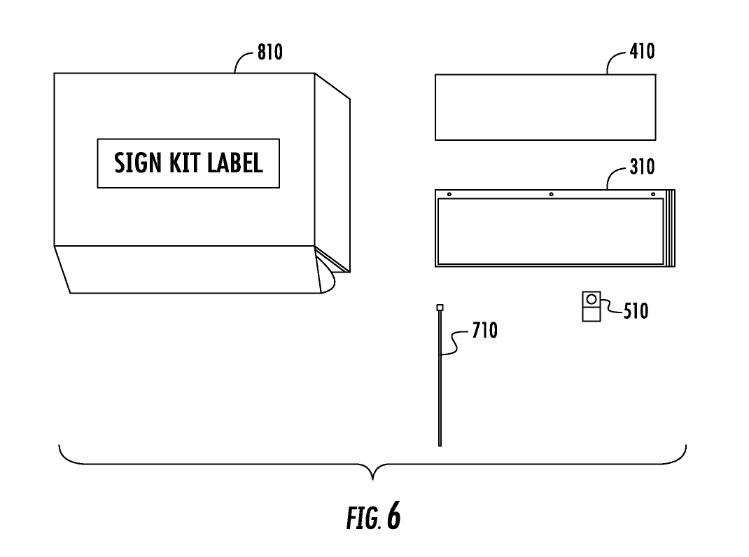

FIG. 6 represents a real estate sign rider kit 810 according to the present invention. The kit 810 consists of a carton 800, 8 rigid inserts 410, 25 protective sign sleeves 310, 50 hang Tabs 510, 50 fasteners 710 (e.g., Cable ties), 50 end flap labels, and assembly instructions. In addition, the carton can be white labeled or printed with any real estate service or product provider, Agency, Franchise, Broker, MLS or Association information on the front panel of the carton as well as Side Rider Size and Kit Contents on the side panel of the carton.

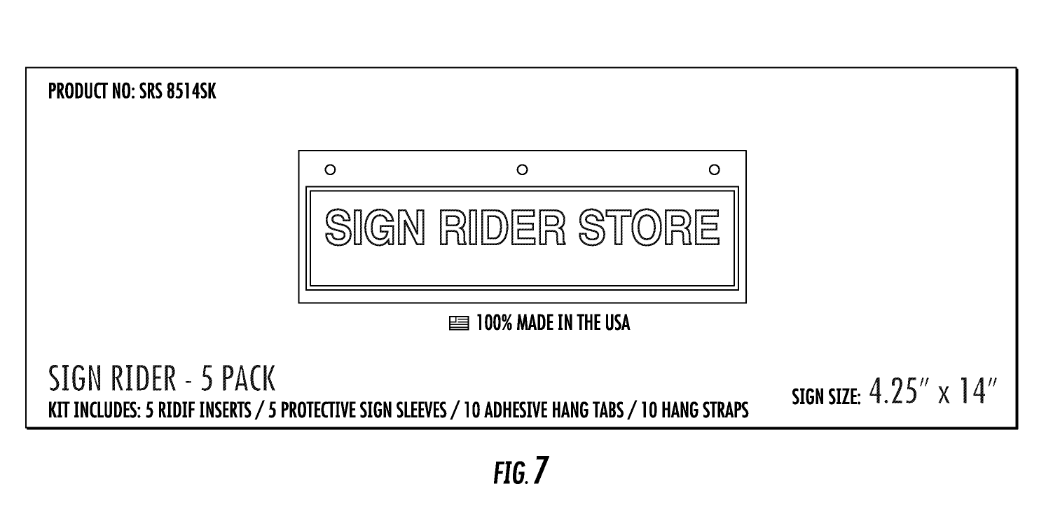

FIG. 7 is a perspective view of a real estate sign rider kit according to the present invention. The kit consists of a printed carton, 5 rigid sheets, 5 protective sign sleeves, 10 hang tabs, 10 fasteners (e.g., Cable ties), 10 end flap labels, and assembly instructions. The carton is printed with Sign Rider Store labeling to identify package contents and assembly instructions. In addition, the carton can be printed with any real estate service or product provider, Agency, Franchise, Broker, MLS or Association information and contents labeling on the front panel of the carton as well as assembly instructions on the back panel of the carton.

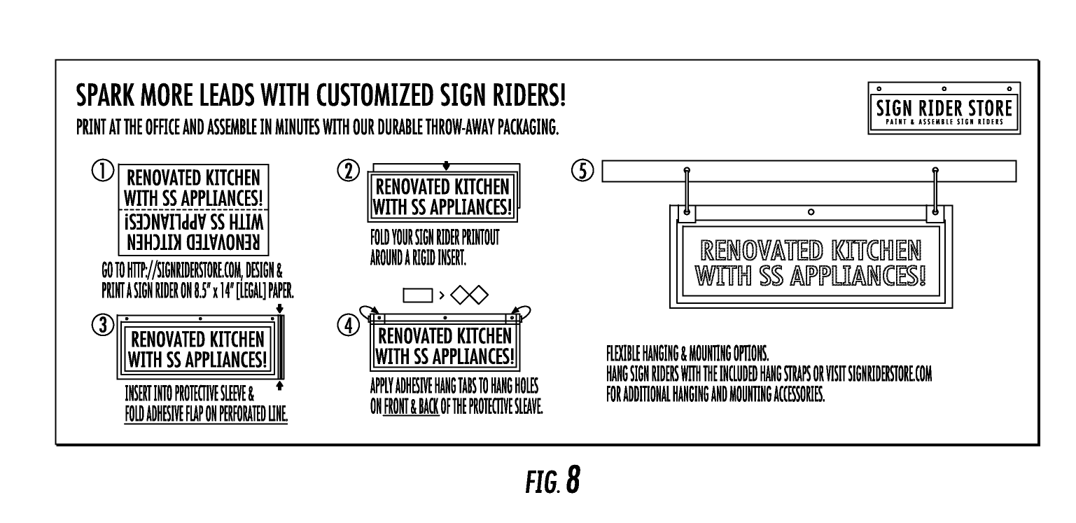

FIG. 8 is a perspective view of sign rider assembly instructions according to the present invention. Assembly instructions can be displayed on the inside lid of the carrier carton, as an included insert inside the package or as part of the printed carton. The customer can cost effectively print sign riders on a desktop or office printer and follow assembly instructions to make one sign rider in minutes. Each Sign Rider can be displayed on the listing property the day a listing contract is signed, which is a big marketing advantage for the Agent.

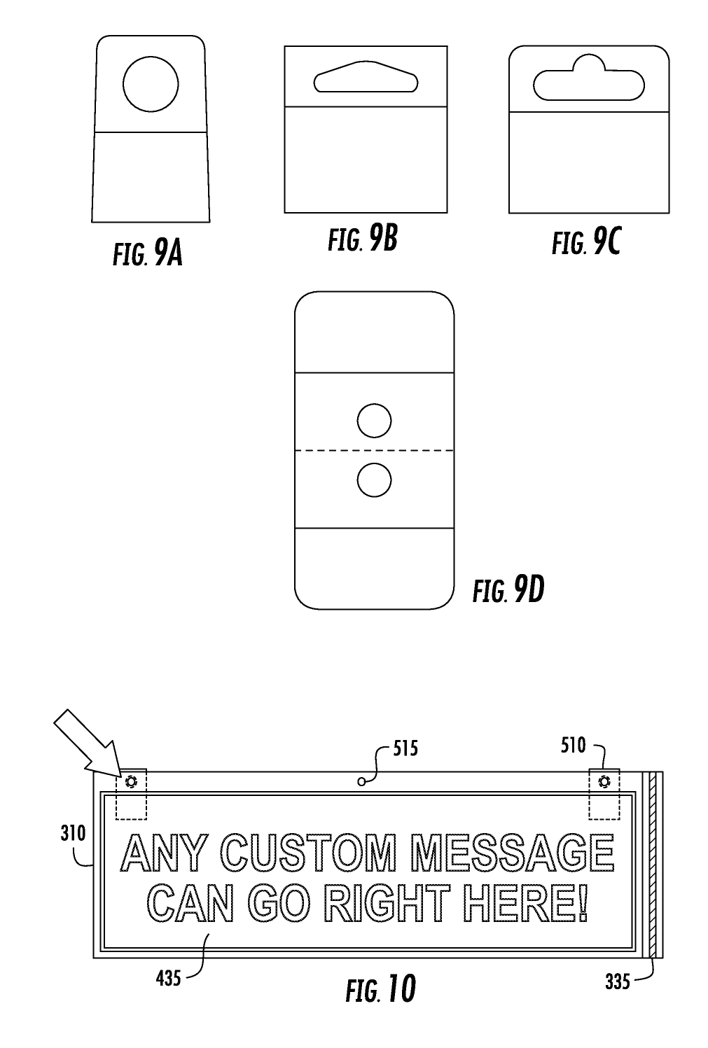

FIGS. 9A, 9B, 9C, and 9D depict various types of hang tab/hole options according to the present invention. Hang tabs can be manufactured into the protective sleeve in various locations or fastened separately using permanent or removable pressure sensitive adhesive to the locations desired. Hang tab holes can be constructed in any effective shape (e.g., a triangle, round or Euro Style shape) that is suitable for the fasteners selected and can be rigid or flexible. Hang tabs may be added to any location on the top, bottom or sides of the protective sign sleeve, which will enable securing fasteners to any perimeter on the protective sign sleeve.

FIG. 10 depicts placement of a hang tab 510 on sign rider 150.

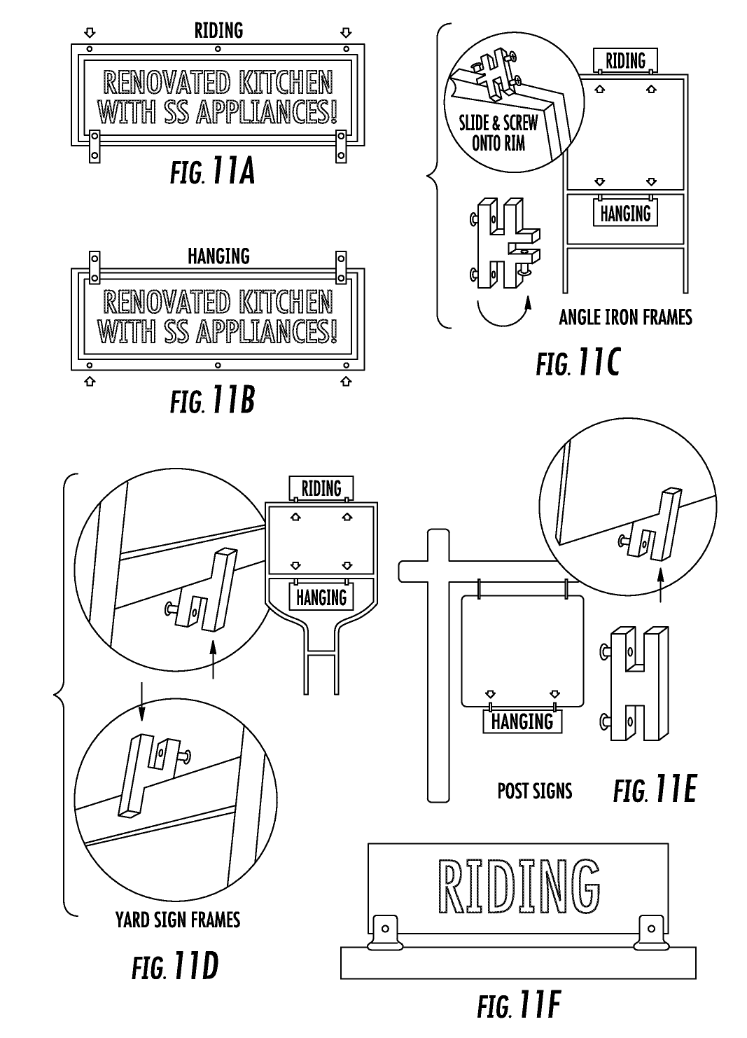

As shown in FIGS. 11A, 11B, 11C, 11D, 11 E, and 11F the sign rider 150 may include rider-clips, tri-Clips and H-Clips. Accordingly, the sign rider may be used to ride protective sign sleeves on the top, bottom or side of any traditional real estate sign.

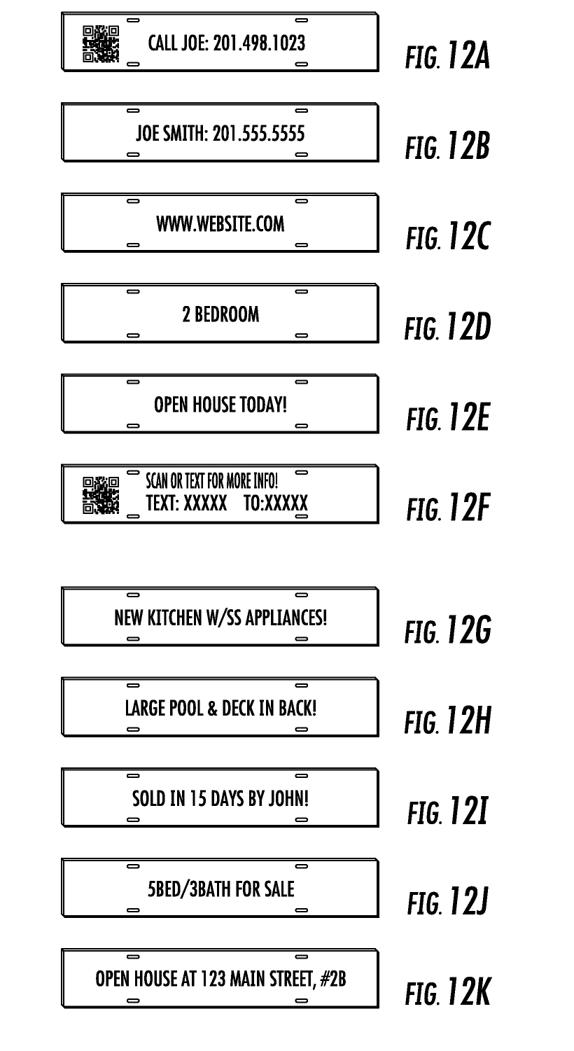

FIGS. 12A, 12B, 12C, 12D, 12E, 12F, 12G, 12H, 12I, 12J, and 12K provides sign rider examples according to the present invention. Real Estate professionals need the flexibility to print what they want when the want it. Information will vary with each listing and may include key agency and/or agent or property specific information, and then sending that information to your desktop or office printer, then assembling a sign rider using components from the sign rider kit.

Sign riders can show a wide variety of information. In real estate for example, embodiments can include Agency and Agent Information (such as name, address, website, contact information, etc. . . . ), property information, property specific SMS text and response code information and/or a wide variety of property characteristics.

The present invention includes the ability to sell the materials via sign rider kits that can include the carton (for example, white labeled or sold directly), rigid plastic inserts, protective sign sleeves, hang tabs, end flap labels, fasteners and assembly instructions.

In some embodiments, the plurality of covers may be selected from printed paper or film in US name A (letter) (8.5″×11″), Legal (8.5×14″), B (Ledger) (11×17″), Super B/Super AC (13×19″), C (17×22″), D (22×34″) and E (34×44″) and Metric Name A5 (148×210 mm), A4 (210×297 mm), A3 (297×420 mm), A3+ (329×483 mm), A2 329×594 mm), A1 (594×841 mm), A0 (841×1189 mm) and combinations thereof.

In some embodiments, the plurality of inserts may be selected from Polypropylene PP fluted plastic sheets, flat Plastic sheets (e.g., PP, PVC, PET, PETG, Coextruded Plastics), Fluted Corrugate (B Flute, E Flute), Cardboard, Reprocor, Duron Pressed Board, Compressed board, Solid bleach Sulfate (SBS) Board, white coated news back board, and combinations thereof. In some embodiments, the inserts may be reusable.

In some embodiments, the plurality protective sign sleeves may include plastic sleeves, plastic bags, and plastic envelopes. The protective sign sleeve may be made using a variety of materials such as but limited to BOPP, LDPE, HDPE, PET, PETG, laminated Polyester/Poly, nylon, extrusion coated nylon. The sleeves, bags or envelopes can be manufactured to match the paper sizes above in the flat or folded in a number of combinations. Permanent, waterproof adhesives can be applied to the lip or closure in various widths (e.g., widths may range from 0.125″ to 1.00″ or more).

In some embodiments, the plurality of fasteners may be selected from plastic cable ties (e.g., 4″, 8″ 11″, 14″ 24″ or larger), twist ties (e.g., 4″-24″ or larger), tag ties, pallet bands, plastic seals, ladder seals, Tug tights, cable seals, wire cut to the desired length, rope or cord cut to the desired length, metal and plastic hooks in various sizes, and combinations thereof.

In some embodiments, the plurality of hang tabs may include flexible plastic, rigid plastic, tyvek, or nylon. The hang tabs may be selected from triangular hang tabs with and without permanent or removable adhesive, round hang tabs with or without permanent or removable adhesive, euro hang tabs with or without permanent or removable adhesive, j-hook hang tabs with or without permanent or removable adhesive and plastic display strips, and combinations thereof. There are a variety of commercial sizes available (e.g., 0.875×1.250″, 1×1.500″, 1×1.750″, 1×2″, 2×2″, which is not intended to be an all-inclusive list).

In some embodiments, the hang tabs may be associated with the protective sign sleeve. In some embodiments, the hang tab will be molded into the protective sleeve, bag or envelope tooling (die) for manufacturing (in essence it will be fabricated into the sleeve, bag or envelope). In some embodiments, the hang tabs are associated with a permanent or removable adhesive. In some embodiments hang tabs will not have adhesive but will be attached by placing adhesive between the sleeve, bag or envelope and hang tabs. The hang tabs may include holes (e.g., triangle, round or Euro style) or any shape, which is suitable for insertion of the fasteners.

In alternative embodiments, the protective sign sleeve may include cut outs or holes suitable for insertion of the fasteners.

In some embodiments, the present invention may include an adhesive. The adhesive may be associated with the hang tab or the flap of the protective sign sleeve. In some embodiments, the adhesive is selected from permanent or removable tape and or glue material. In some embodiments, a band of permanent or removable adhesive (e.g., ⅛″, ½″, ¾″, 1″ or more) is applied to the lip of the flap and when folded seals the lip of the flap to the sleeve, bag or envelope. In some embodiments, a band of permanent adhesive (e.g., ⅛″, ½″, ¾″, 1″ or more) is applied to the lip flap of the protective sleeve and when folded, seals to both the top half and bottom half of the sleeve, bag or envelope simultaneously creating a watertight seal. Permanent adhesive end flap labels can be added to the top and bottom of the flap seal to ensure waterproof protection.

In alternate embodiments, the present invention may include a male/female coupling seal (e.g., zip lock) may be used to seal the protective sleeve and create a watertight seal.

Sign rider kit components are being evaluated with a goal to improve environmental impact. Printed-paper, Rigid Inserts and Sign Sleeves will be manufactured with recyclable materials. In addition, Rigid Plastic Inserts can be reused at least 3 times, which means that customers will consistently use 68% less rigid material (e.g., printed aluminum, steel and plastic corrugate used for realty signs and rider signs today vs. unprinted rigid inserts used with the present invention).

1. A real estate sign comprising:
a protective plastic sign sleeve, wherein said sleeve comprises a flap and at least one opening;
an insert;
a sign comprising indicia, wherein said sign is associated with said insert;
at least one hang tab;
at least one end flap label; and
a fastener.

2. (canceled)

3. A method of creating a real estate sign comprising the steps of:
printing a sign comprising indicia;
associating said sign with a rigid insert;
obtaining a protective plastic sign sleeve, wherein said plastic sleeve comprises an outer surface, an inner surface, at least one opening and a flap associated with said opening;
inserting said sign and insert into the opening of said protective plastic sign sleeve;
sealing said flap to said outer surface of said protective plastic sign sleeve;
associating at least one hang tab to said outer surface of said protective plastic sign sleeve; and
fastening said hang tab and protective plastic sign sleeve to a surface with at least one fastener.

4. (canceled)

5. A sign kit used for marketing or advertising for any product or service comprising:
a plurality of sleeves;
a plurality of inserts;
a plurality of fasteners;
a plurality of hang tabs;
a plurality of end flaps; and
and an instruction set.
